(19) United States
(12) Patent Application Publication
(10) Pub. No.: US 2010/0079409 A1
(43) Pub. Date: Apr. 1, 2010

(54) TOUCH PANEL FOR AN INTERACTIVE INPUT SYSTEM, AND INTERACTIVE INPUT SYSTEM INCORPORATING THE TOUCH PANEL

(75) Inventors: Roberto A.L. Sirotich, Calgary (CA); Wallace I. Kroeker, Calgary (CA); Edward Tse, Calgary (CA); Joe Wright, Strathmore (CA); George Clarke, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary (CA)

(21) Appl. No.: 12/240,953

(22) Filed: Sep. 29, 2008

(51) Int. Cl. G06F 3/042

(52) U.S. Cl. 345/175

(57) ABSTRACT

A touch panel for an interactive input system and interactive input system incorporating the touch panel is provided. The touch panel includes an optical waveguide layer and a resilient diffusion layer. The resilient diffusion layer is against the optical waveguide layer and causes light traveling within the optical waveguide layer to escape only when compressed against the optical waveguide layer at one or more touch points.

### FIELD OF THE INVENTION

The present invention relates generally to interactive input systems and in particular, to a touch panel for an interactive input system and to an interactive input system incorporating the same.

### BACKGROUND OF THE INVENTION

Interactive input systems that allow users to inject input (i.e. digital ink, mouse events etc.) into an application program using an active pointer (eg. a pointer that emits light, sound or other signal), a passive pointer (eg. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In a multi-touch interactive input system, the machine vision system captures images including the point(s) of escaped light, and processes the images to identify the position of the pointers on the waveguide surface based on the point(s) of escaped light for use as input to application programs.

One example of an FTIR multi-touch interactive input system is disclosed in United States Patent Application Publication No. 2008/0029691 to Han. Han discloses an optical waveguide in the form of a clear acrylic sheet, directly against a side of which multiple high-power infrared LEDs (light emitting diodes) are placed. The infrared light emitted by the LEDs into the acrylic sheet is trapped between the upper or lower surfaces of the acrylic sheet due to total internal reflection. A diffuser display surface is disposed alongside the non-contact side of the acrylic sheet with a small gap between the two in order to keep the diffuser from frustrating the total internal reflection. According to one embodiment, a compliant surface overlay is disposed adjacent the contact surface of the acrylic sheet, with another small gap between the two layers in order to prevent the compliant surface overlay from frustrating the total internal reflection unless it has been touched. When touched, the compliant surface overlay in turn touches the acrylic sheet and frustrates the total internal reflection.

Improvements in FTIR touch panels are desired. For example, the configurations proposed by Han include at least one dedicated spacing layer for ensuring that the diffuser does not contact the acrylic sheet. Creating the spacing layer and tensioning the diffuser accordingly create manufacturing challenges and increase the thickness and complexity of the touch panel. In Han's embodiments that include a compliant surface overlay, there is the similar additional consideration of ensuring suitable spacing between the compliant surface overlay and the acrylic sheet. Furthermore, wear and tear, and changes in relative humidity typically affect the compliant surface overlay, causing it to sag. This can result in errant contacts with the acrylic sheet, and thus false touches.

It is therefore an object of the present invention to provide a novel touch panel for an interactive input system and a novel interactive input system incorporating the same.

### SUMMARY OF THE INVENTION

Accordingly, in one aspect there is provided a touch panel for an interactive input system comprising:

an optical waveguide layer; and

a resilient diffusion layer against the optical waveguide layer causing light traveling within the optical waveguide layer to escape only when compressed against the optical waveguide layer at one or more touch points.

According to another aspect there is provided an interactive input system comprising:

a touch panel comprising:
an optical waveguide layer; and
a resilient diffusion layer against the optical waveguide layer causing light traveling within the optical waveguide layer to escape only when compressed against the optical waveguide layer at one or more touch points; and

processing structure responsive to touch input made on said touch panel and updating the image presented on said display surface to reflect user input based on the one or more touch points.

The touch panel provides advantages over prior systems due at least in part to its use of the resilient diffusion layer against the optical waveguide layer obviating the need for an air gap and thus simplifying manufacturing.

### BRIEF DESCRIPTION OF THE DRAWINGS

Embodiments will now be described more fully with reference to the accompanying drawings in which:

FIG. 1 is a perspective view of an interactive input system;

FIG. 2 is a side sectional view of the interactive input system of FIG. 1;

FIG. 3 is a perspective view of a USB port/switch for the interactive input system of FIG. 1;

FIGS. 4 through 9 are perspective views of portions of the interactive input system showing heat management provisions for the interactive input system of FIG. 1;

FIG. 10a is a sectional view of a table top and touch panel for the interactive input system of FIG. 1;

FIG. 10b is a sectional view of the touch panel of FIG. 10a, having been contacted by a pointer;

FIG. 11 is a perspective view of an alternative interactive input system;

FIG. 12 is an image captured by an imaging device of the interactive input system of FIG. 11; and

FIG. 13 is a sectional view of an alternative table top and touch panel.

### DETAILED DESCRIPTION OF THE EMBODIMENTS

In the following, a touch panel for an interactive input system and an interactive input system incorporating the same are described. The touch panel cooperates with other components of the interactive input system to provide touch information from one or multiple simultaneous pointers at high spatial and temporal resolutions, thereby exhibiting excellent response characteristics.

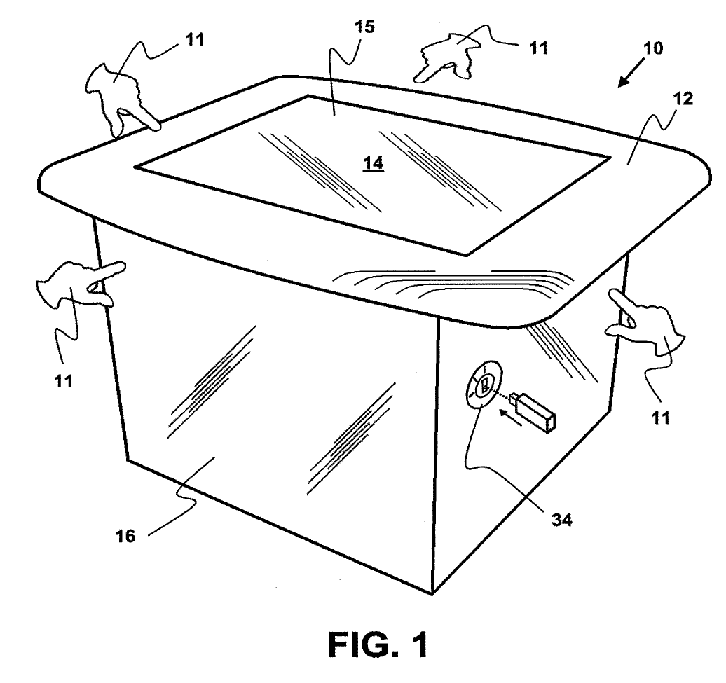

Turning now to FIG. 1, a perspective diagram of an interactive input system in the form of a touch table is shown and is generally identified by reference numeral 10. Touch table 10 comprises a table top 12 mounted atop a cabinet 16. In this embodiment, cabinet 16 sits atop wheels 18 that enable the touch table 10 to be easily moved from place to place in a classroom environment. Integrated into table top 12 is a coordinate input device in the form of a frustrated total internal refraction (FTIR) based touch panel 14 that enables detection and tracking of one or more pointers 11, such as fingers, pens, hands, cylinders, or other objects, applied thereto.

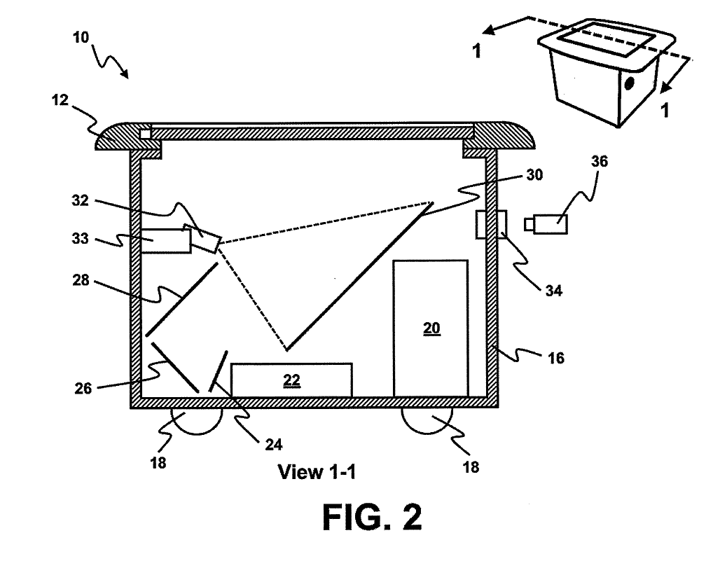

Cabinet 16 supports the table top 12 and touch panel 14, and houses a processing structure 20 (see FIG. 2) executing a host application and one or more application programs, with which the touch panel 14 communicates. Image data generated by the processing structure 20 is displayed on the touch panel 14 allowing a user to interact with the displayed image via pointer contacts on the display surface 15 of the touch panel 14. The processing structure 20 interprets pointer contacts as input to the running application program and updates the image data accordingly so that the image displayed on the display surface 15 reflects the pointer activity. In this manner, the touch panel 14 and processing structure 20 form a closed loop allowing pointer interactions with the touch panel 14 to be recorded as handwriting or drawing or used to control execution of the application program.

The processing structure 20 in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory etc.) and a system bus coupling the various computer components to the processing unit.

The processing structure 20 runs a host software application/operating system which, during execution, presents a graphical user interface comprising a canvas page or palette (i.e. a background), upon which graphic widgets are displayed. In this embodiment, the graphical user interface is presented on the touch panel 14, such that freeform or handwritten ink objects and other objects can be input and manipulated via pointer interaction with the display surface 15 of the touch panel 14.

FIG. 2 is a side elevation cutaway view of the touch table 10. The cabinet 16 supporting table top 12 and touch panel 14 also houses a horizontally-oriented projector 22, an infrared (IR) filter 24, and mirrors 26, 28 and 30. An imaging device 32 in the form of an infrared-detecting camera is mounted on a bracket 33 adjacent mirror 28. The system of mirrors 26, 28 and 30 functions to “fold” the images projected by projector 22 within cabinet 16 along the light path without unduly sacrificing image size. The overall touch table 10 dimensions can thereby be made compact.

The imaging device 32 is aimed at mirror 30 and thus sees a reflection of the display surface 15 in order to mitigate the appearance of hotspot noise in captured images that typically must be dealt with in systems having imaging devices that are aimed directly at the display surface 15. Imaging device 32 is positioned within the cabinet 16 by the bracket 33 so that it does not interfere with the light path of the projected image.

During operation of the touch table 10, processing structure 20 outputs video data to projector 22 which, in turn, projects images through the IR filter 24 onto the first mirror 26. The projected images, now with IR light having been substantially filtered out, are reflected by the first mirror 26 onto the second mirror 28. Second mirror 28 in turn reflects the images to the third mirror 30. The third mirror 30 reflects the projected video images onto the display (bottom) surface of the touch panel 14. The video images projected on the bottom surface of the touch panel 14 are viewable through the touch panel 14 from above. The system of three mirrors 26, 28, configured as shown provides a compact path along which the projected image can be channeled to the display surface. Projector 22 is oriented horizontally in order to preserve projector bulb life, as commonly-available projectors are typically designed for horizontal placement.

An external data port/switch 34, in this embodiment a Universal Serial Bus (USB) port/switch, extends from the interior of the cabinet 16 through the cabinet wall to the exterior of the touch table 10 providing access for insertion and removal of a USB key 36, as well as switching of functions.

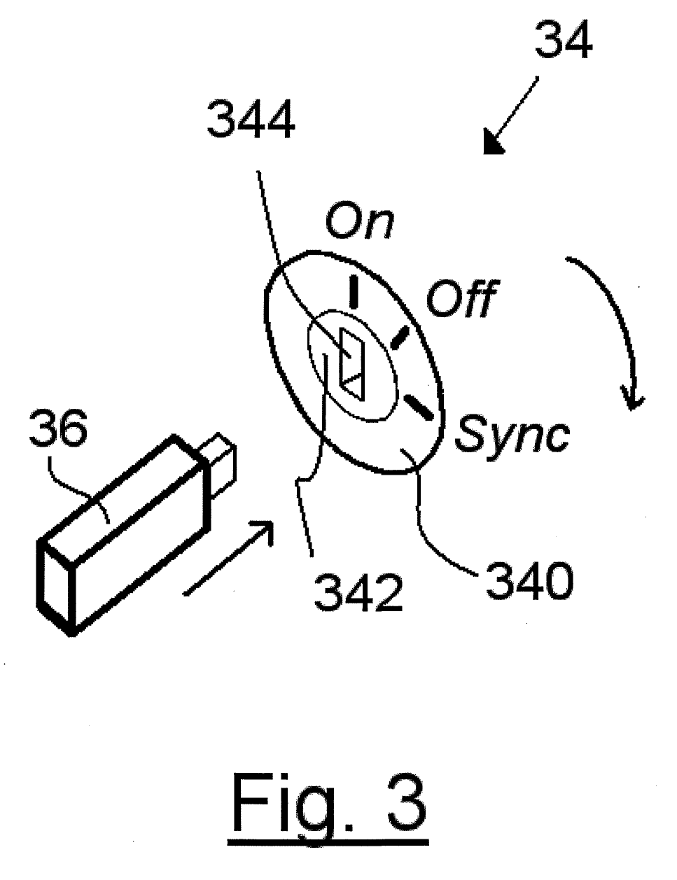

FIG. 3 is a perspective view of the front of the USB port/switch 34. As can be seen, USB port/switch 34 includes a casing 340 housing a rotatable cylinder 342 which, in turn, has a keyslot 344 therein for receiving a USB key 36. When a USB key 36 is inserted into the keyslot 344, the user gripping the USB key 36 can rotate the cylinder 342 clockwise or counterclockwise between three switch positions: OFF; ON; and SYNC. The USB port/switch 34 thereby enables a user to, in a single interface unit, connect the USB key 36 to the processing structure 20 but also control the touch table 10 and control provision of data to and from the USB key 36. For example, when a user inserts a USB key 36 into the keyslot 344 while the cylinder 342 is in the OFF position, the user can activate the touch table 10 upon rotating the USB key 36 so as to rotate the cylinder 342 to the ON position. During this procedure, the processing structure 20 can optionally conduct an authentication procedure by processing an electronic authentication file/software key for preventing unauthorized use retrieved from the USB key 36, and can accordingly activate the touch table 10 for use. When a user rotates the authorized USB key 36 to the SYNC position, the processing structure 20 automatically uploads from the USB key 36 a configuration file with configuration data for configuring application programs being run on the touch table 10. Such configuration data may include words, pictures, music and other configuration data custom-defined by a user for configuring a particular collaborative application template for use during a session. A USB key 36 may also include any required software or data for performing upgrades, fixes and the like. Various users could store different configuration data on respective USB keys 36. Preferably the USB port/switch 34 is configured to physically receive only a particular shape of USB key 36, so as to provide a layer of physical security to prevent unauthorized users from inserting a standard USB key 36 into the keyslot 344 and making use of the activation and synchronizing functions, even in the case where there are no electronic authentication provisions being used.

The USB port/switch 34, projector 22, and imaging device 32 are each connected to and managed by the processing structure 20. A power supply (not shown) supplies electrical power to the electrical components of the touch table 10. The power supply may be an external unit or, for example, a universal power supply within the cabinet 16 for improving portability of the touch table 10. The cabinet 16 fully encloses its contents in order to restrict the levels of ambient visible and infrared light entering the cabinet 16 thereby to facilitate satisfactory signal to noise performance. However, provision is made for the flow of air into and out of the cabinet 16 for managing the heat generated by the various components housed inside the cabinet 16.

It is desired to reduce the amount of interfering ambient light entering the cabinet 14. However, doing this can compete with various techniques for managing heat within the cabinet 16. The touch panel 14, the projector 22, and the processing structure 20 are all sources of heat, and such heat if contained within the cabinet 16 for extended periods of time can reduce the life of components, affect performance of components, and create heat waves that can distort the optical components of the touch table 10. As such, provisions for managing heat by introducing cooler ambient air while exhausting hot air are provided.

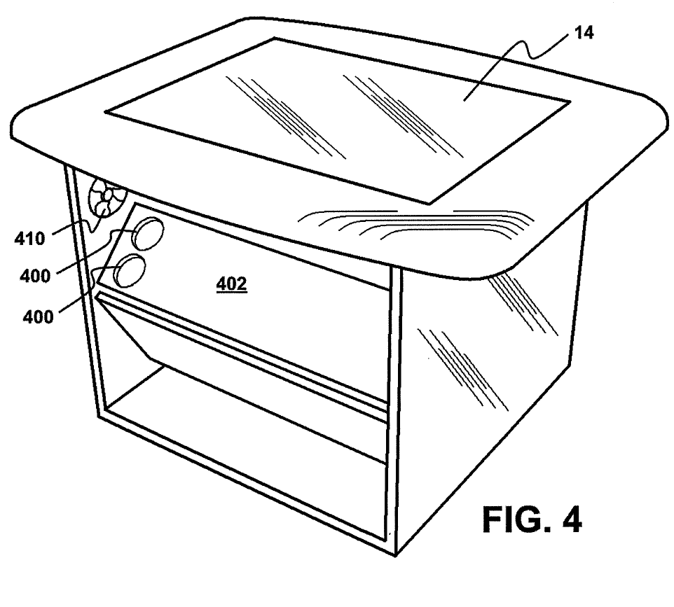

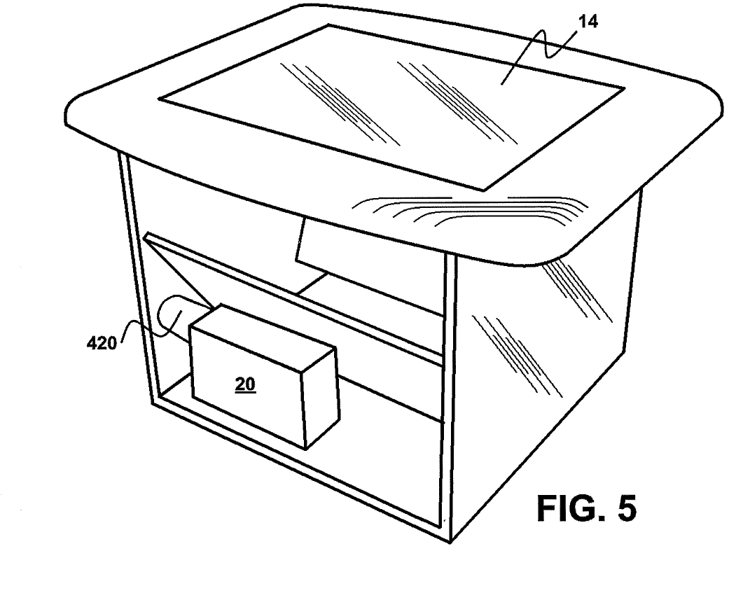

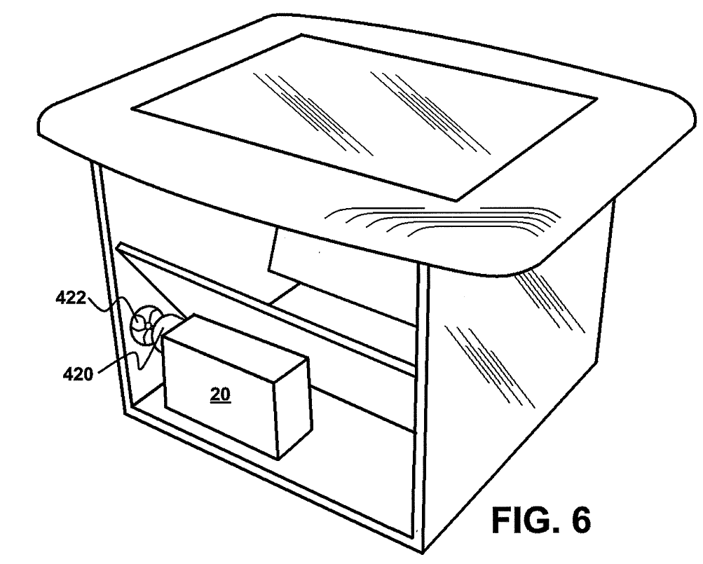

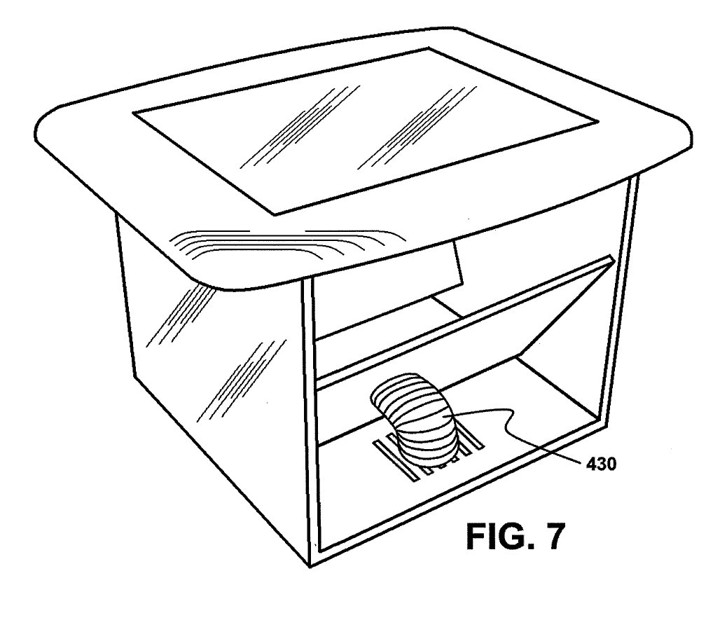

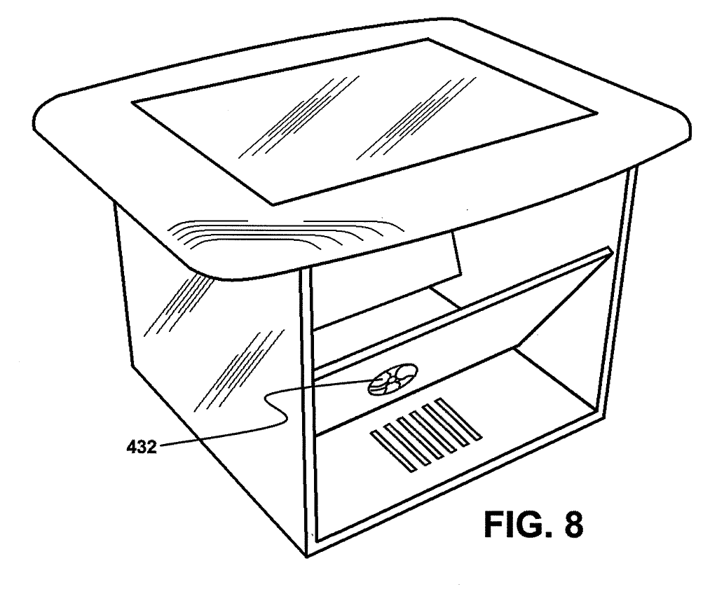

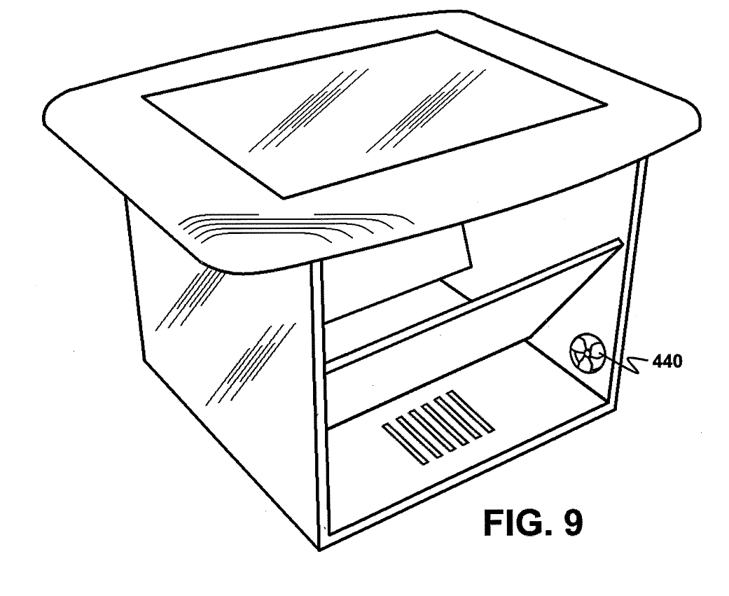

FIGS. 4 through 9 are perspective views showing heat management provisions for the touch table 10. In FIG. 4, “chimney holes” 400 are provided in the support 402 for mirror 28 that direct rising hot air to a fan 410, which draws hot air from inside the cabinet 16. FIGS. 5 and 6 show a duct 420 for channeling hot air exiting the processing structure 20 directly to the exterior wall of the cabinet 16, where a fan 422 draws the hot air out of the cabinet 16. FIGS. 7 and 8 show a duct 430 for channeling hot air exiting the projector 22 directly to the exterior (bottom) wall of the cabinet 16, where a fan 432 draws the hot air out of the cabinet 16. An input fan 440 is shown in FIG. 9 at the exterior wall of the cabinet 16 for drawing in cool air from outside of the cabinet 16. The fans 410, 422, 432, and 440 may be any suitable type, such as muffin or squirrel cage fans, as desired, that connect to the power supply (not shown) for the touch table 10. The heat management provisions described above and shown in FIGS. 4 through 9 significantly lower the internal operating temperature at various key points within the cabinet 16, to the advantage of the operation of the touch table 10. Furthermore, the use of ducting further reduces the amount of ambient light entering the cabinet 16, allowing for direct cooling in light-sensitive areas of the cabinet 16. In order to avoid distortion of mirrors 26, 28, or IR filter 24 due to heat, fans and ducts may be arranged to directly cool these components also.

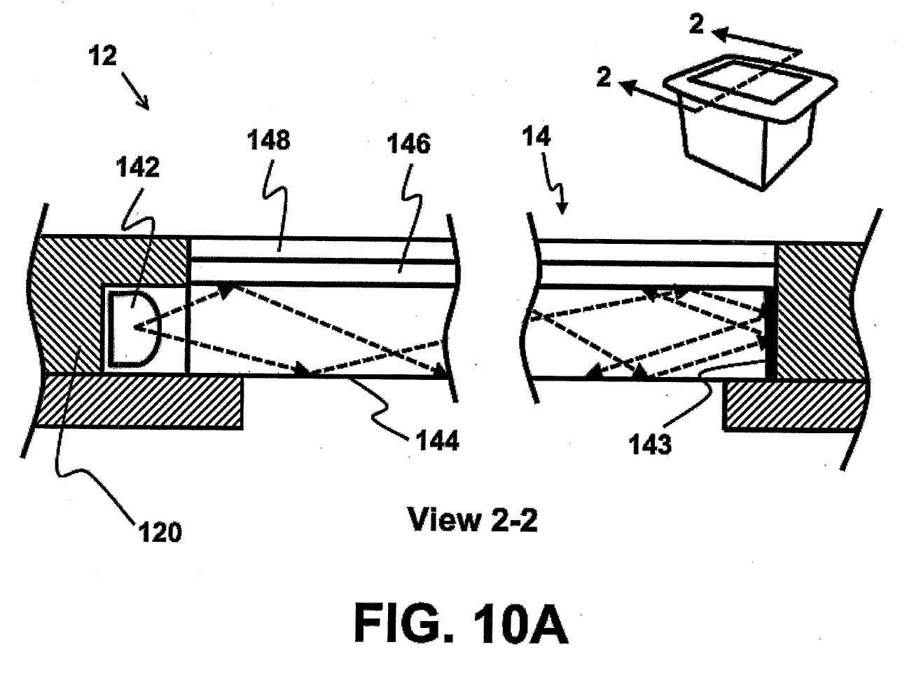

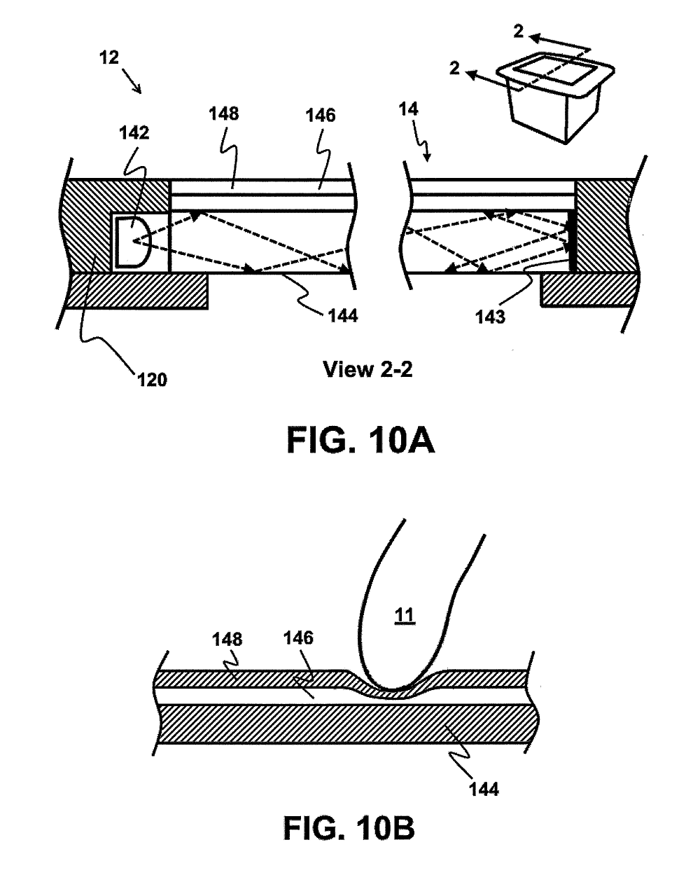

As set out above, the touch panel 14 of touch table 10 operates based on the principles of frustrated total internal reflection (FTIR). FIG. 10a is a sectional view of the table top 12 and touch panel 14 for the touch table 10 shown in FIG. 1. Table top 12 comprises a frame 120 supporting the touch panel 14. In this embodiment, frame 120 is composed of plastic.

Touch panel 14 comprises an optical waveguide layer 144 that, according to this embodiment, is a sheet of acrylic. A resilient diffusion layer 146, in this embodiment a layer of V-CARE® V-LITE® barrier fabric manufactured by Vintex Inc. of Mount Forest, Ontario, Canada, lies against the optical waveguide layer 144. V-CARE® V-LITE® barrier fabric comprises a durable, lightweight polyvinylchloride (PVC) coated yarn that suitably diffuses visible light for displaying projected images. V-CARE® V-LITE® barrier fabric also has a rubberized backing with, effectively, tiny bumps enabling the material to sit directly on the surface of the optical waveguide layer 144 without causing significant, if any, frustration of the total internal reflection of IR light in the optical waveguide layer 144 until such time as it is compressed against the surface of the optical waveguide layer 144. The rubberized backing also grips the optical waveguide layer 144 to resist its sliding relative to the optical waveguide layer 144 as a pointer 11 is moved along the resilient diffusion layer 146, thereby resisting bunching up.

The lightweight weave of the V-CARE® V-LITE® barrier fabric along with the tiny bumps obviate the requirement to specifically engineer an air gap between the diffusion layer 146 and the optical waveguide layer 144 and to deal with tensioning the diffusion layer 146 so as not to sag into the air gap and cause a false touch.

Another advantage of the V-CARE® V-LITE® barrier fabric is that it is highly resilient and therefore well-suited to touch sensitivity; it very quickly regains its original shape when pressure from a pointer is removed, due to the natural tensioning of the weave structure, abruptly ceasing the release of IR light from the optical waveguide layer 144 that occurs at the touch points. As a result, the touch panel 14 is able to handle touch points with high spatial and temporal resolution. The weave structure also diffuses light approaching the touch table 10 from above, thereby inhibiting the ingress of visible light into the cabinet 16.

Another attribute of the V-CARE® V-LITE® barrier fabric is that it reflects escaping IR light suitably towards mirror 30, and also permits, within an operating range, emission of varying amounts of escaping light as a function of the degree to which it is compressed against the optical waveguide layer 144. As such, image processing algorithms can gauge a relative level of pressure applied based on the amount of light being emitted from a touch point, and can provide this information as input to application programs thereby providing increased degrees of control over certain applications. The diffusion layer 146 substantially reflects the IR light escaping the optical waveguide layer 144 down into the cabinet 16, and diffuses visible light being projected onto it in order to display the projected image.

Overlying the resilient diffusion layer 146 on the opposite side of the optical waveguide layer 144 is a clear, protective layer 148 having a smooth touch surface. In this embodiment, the protective layer 148 is a thin sheet of polycarbonate material over which is applied a hardcoat of Marnot® material, produced by Tekra Corporation of New Berlin, Wisconsin, U.S.A. While the touch panel 14 may function without the protective layer 148, the protective layer 148 permits use of the touch panel 14 without undue discoloration, snagging or creasing of the underlying diffusion layer 146, and without undue wear on users' fingers. Furthermore, the protective layer 148 provides abrasion, scratch and chemical resistance to the overall touch panel 14, as is useful for panel longevity.

The protective layer 148, diffusion layer 146, and optical waveguide layer 144 are clamped together at their edges as a unit and mounted within the table top 12. Over time, prolonged use may wear one or more of the layers. As desired, the edges of the layers may be unclamped in order to inexpensively provide replacements for the worn layers. It will be understood that the layers may be kept together in other ways, such as by use of one or more of adhesives, friction fit, screws, nails, or other fastening methods.

A bank of infrared light emitting diodes (LEDs) 142 is positioned along at least one side surface of the optical waveguide layer 144 (into the page in FIG. 10a). Each LED 142 emits infrared light into the optical waveguide layer 144. In this embodiment, the side surface along which the LEDs 142 are positioned is flame-polished to facilitate reception of light from the LEDs 142. An air gap of 1-2 millimetres (mm) is maintained between the LEDs and the side surface of the optical waveguide layer 144 in order to reduce heat transmittance from the LEDs 142 to the optical waveguide layer 142, and thereby mitigate heat distortions in the acrylic optical waveguide layer 144. Bonded to the other side surfaces of the optical waveguide layer 144 is reflective tape 143 to reflect light back into the optical waveguide layer 144 thereby saturating the optical waveguide layer 142 with infrared illumination.

In operation, IR light is introduced via the flame-polished side surface of the optical waveguide layer 144 in a direction generally parallel to its large upper and lower surfaces. The IR light does not escape through the upper or lower surfaces of the optical waveguide layer 144 due to total internal reflection (TIR) because its angle of incidence at the upper and lower surfaces is not sufficient to allow for its escape. The IR light reaching other side surfaces is generally reflected entirely back into the optical waveguide layer 144 by the reflective tape 143 at the other side surfaces.

As shown in FIG. 10b, when a user contacts the display surface 15 with a pointer 11, the pressure of the pointer 11 against the protective layer 148 compresses the resilient diffusion layer 146 against the optical waveguide layer 144, causing the index of refraction of the optical waveguide layer 144 at the contact point of the pointer 11, or “touch point”, to change. This change “frustrates” the TIR at the touch point causing IR light to reflect at an angle that allows it to escape from the optical waveguide layer 144 in a direction generally perpendicular to the plane of the optical waveguide layer 144 at the touch point. The escaping IR light reflects off of the pointer 11 and scatters locally downward through the optical waveguide layer 144 and exits the optical waveguide layer 144 through its bottom surface. The escaping IR light from the touch point reaches the third mirror 30. This occurs for each pointer 11 as it contacts the display surface 15 at a respective touch point.

As each touch point is moved along the display surface 15, compression of the resilient diffusion layer 146 against the optical waveguide layer 144 occurs and thus escaping of IR light tracks the touch point movement. During touch point movement or upon removal of the touch point, decompression of the diffusion layer 146 where the touch point had previously been due to the resilience of the diffusion layer 146, causes escape of IR light from optical waveguide layer 144 to once again cease. As such, IR light escapes from the optical waveguide layer 144 only at touch point location(s).

Imaging device 32 captures two-dimensional, IR video images of the third mirror 30. IR light having been filtered from the images projected by projector 22, in combination with the cabinet 16 substantially keeping out ambient light, ensures that the background of the images captured by imaging device 32 is substantially black. When the display surface 15 of the touch panel 14 is contacted by one or more pointers as described above, the images captured by IR camera 32 comprise one or more bright points corresponding to respective touch points. The processing structure 20 receives the captured images and performs image processing to detect the coordinates and characteristics of the one or more bright points in the captured images, as described in further detail in U.S. patent application Ser. No. (ATTORNEY DOCKET NO. 6355-243) entitled “METHOD AND SYSTEM FOR CALIBRATING AN INTERACTIVE INPUT SYSTEM AND INTERACTIVE INPUT SYSTEM EXECUTING THE METHOD” to Holmgren et al. filed on even date herewith and assigned to the assignee of the subject application, the content of which is incorporated herein by reference in its entirety. The detected coordinates are then mapped to display coordinates as described in the Holmgren et al. reference referred to above, and provided to the host application.

The host application tracks each touch point based on the received touch point data, and handles continuity processing between image frames. More particularly, the host application receives touch point data from frames and based on the touch point data determines whether to register a new touch point, modify an existing touch point, or cancel/delete an existing touch point. Thus, the host application registers a Contact Down event representing a new touch point when it receives touch point data that is not related to an existing touch point, and accords the new touch point a unique identifier. Touch point data may be considered unrelated to an existing touch point if it characterizes a touch point that is a threshold distance away from an existing touch point, for example. The host application registers a Contact Move event representing movement of the touch point when it receives touch point data that is related to an existing pointer, for example by being within a threshold distance of, or overlapping an existing touch point, but having a different focal point. The host application registers a Contact Up event representing removal of the touch point from the display surface 15 of the touch panel 14 when touch point data that can be associated with an existing touch point ceases to be received from subsequent images. The Contact Down, Contact Move and Contact Up events are passed to respective elements of the user interface such as graphical objects, widgets, or the background/canvas, based on the element with which the touch point is currently associated, and/or the touch point's current position.

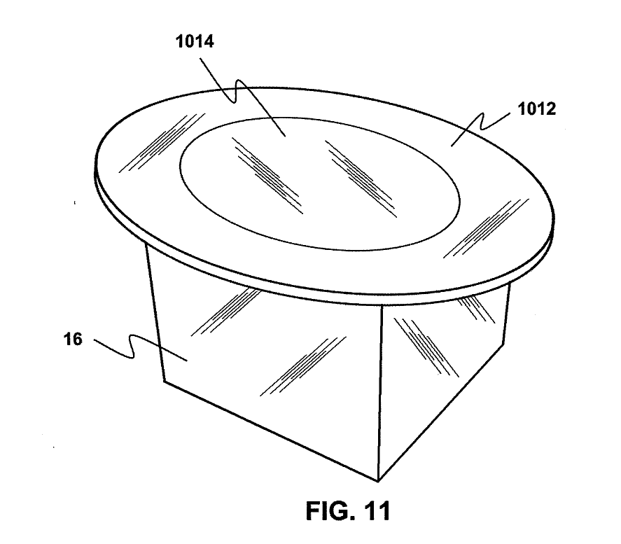

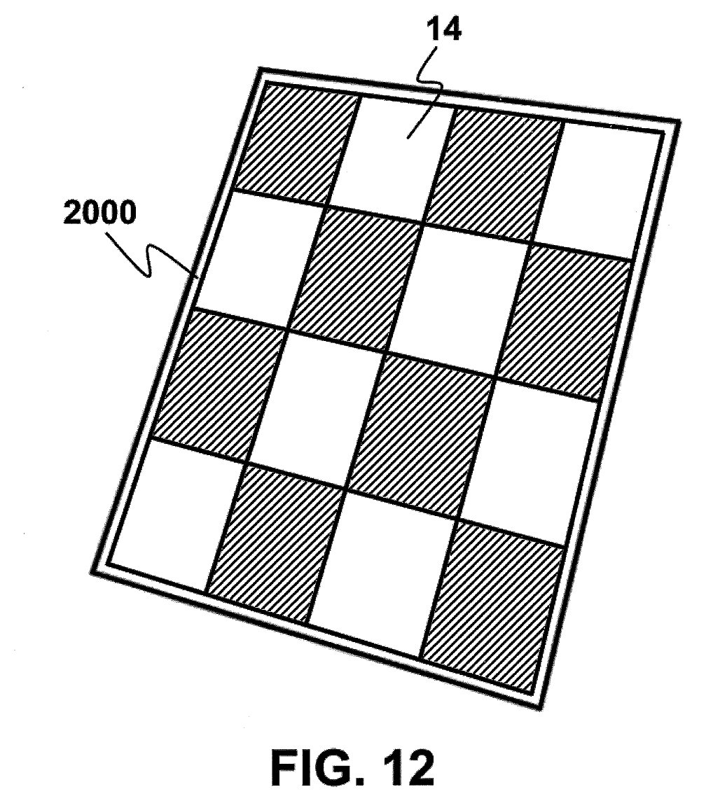

Although an embodiment of the touch table has been described above with reference to the drawings, it will be understood that alternative embodiments are possible. For example, in alternative embodiments, the shape of the table top and/or touch panel may be customized to suit various needs and/or requirements. FIG. 11 shows an alternative table top 1012 and touch panel 1014 with different shapes. To assist with image processing of this alternative shape, the edge of the touch screen 1014 appears to the imaging device as a bright perimeter 2000 (see the rectangular bright perimeter shape in FIG. 12 for example). Based on this bright perimeter, the processing structure can determine the shape of the touch panel, and mask the projected image accordingly to cooperate with the shape of the touch panel 1014. Other table top and touch panel shapes are of course possible. Also, other methods of determining the bounds of the touch screen are possible and may include using markers visible to the imaging device.

The table top 12 may be made of any rigid, semi-rigid or combination of rigid and malleable materials such as plastics, resins, wood or wood products, metal, or other suitable material or materials. For example, the table top 12 could be made of plastic and coated with malleable material such as closed cell neoprene. This combination would provide rigidity while offering a padded surface for users.

In alternative embodiments, processing structure 20 may be located external to cabinet 16, and may communicate with the other components of the touch table 10 via a wired connection such as Ethernet, RS-232, or USB, and the like, and/or a wireless connection such as Bluetooth™, or WiFi, and the like.

Alternatives to the three mirror system shown herein may include various optical systems comprising one or multiple mirrors that function to effectively project an image onto the resilient diffusion layer 146. Furthermore, multiple imaging devices 32 could be used to capture images for a larger touch panel 14 or multiple touch panels 14, each directed at a single mirror such as mirror 30, or at respective different mirrors. In such a case, multiple projectors 22 may be employed with projected images having been stitched for continuous display.

Alternative embodiments include an imaging device 32 mounted against the interior wall of cabinet 16, and directed at mirror 30, as opposed to being mounted on the bracket 33. Still other alternatives include mounting the imaging device 32 so as to be directed at any of the mirrors 26, 28 or 30 without interfering with the light path. Such alternatives may comprise employing a half-mirror towards the back of which is directed an imaging device 32.

Though it has been found to be advantageous to avoid having imaging device 32 directly view the diffusion layer 146 itself due to the consideration of having to process out image artifacts due to “hot spots”, in an alternative embodiment, imaging device 32 could indeed be positioned to directly view the diffusion layer 146. In order to further reduce the appearance of hot spots, a polarizer may be placed between the imaging device 32 and the diffusion layer 146, and/or mirror 30 may be polarized.

V-CARE® V-LITE® barrier fabric described above for use as a resilient diffusion layer 144 diffuses visible light, reflects infrared light, resists sliding relative to the optical waveguide layer 144, can sit against the optical waveguide layer 144 without false touches, and is highly resilient so as to enable high spatial and temporal resolution of a touch point. It will be understood however that alternative resilient materials having suitable properties may be employed. For example, certain of the above properties could be provided by one or more material layers alone or in a combination. For example, a resilient diffusion layer could comprise a visible diffusion layer for displaying the projected images, overlying an infrared reflecting layer for reflecting infrared light escaping from the optical waveguide layer 144, which itself overlies a gripping layer facing the optical waveguide layer 144 for resisting sliding while leaving a suitable air gap for not significantly frustrating total internal reflection until pressed against the optical waveguide layer 144.

One alternative material is Darlexx® fabric provided by Shawmut Advanced Material Solutions of West Bridgewater, MA, U.S.A. However, it has been found that Darlexx® does not tend to rebound as quickly as does V-CARE® V-LITE® barrier fabric.

Other material for resilient diffusion layer 146 may be employed that, for example, is smooth enough to provide advantages similar to those of the additional protective layer 148 described above.

Alternative embodiments may employ a Fresnel lens along the side of the optical waveguide layer 144 opposite the resilient diffusion layer 146, in order to brighten the projected image while reducing reflections back into cabinet 16 off of the optical waveguide layer 144.

It will also be understood that the optical waveguide layer 144 may be formed from a transparent or semi-transparent material other than acrylic, such as glass.

While a generally planar touch panel 14 has been described, it will be understood that the principles set out above may be applied to create non-planar touch panels or touch panels having multiple intersection planes or facets where total internal reflection of a non- or multi-planar optical waveguide layer is frustrated by compression of a resilient diffusion layer that is against and follows the surface contour of the optical waveguide layer. Examples of non-planar shapes include arcs, semi-circles, or other regular or irregular shapes. A single or multiple imaging devices 32 could receive images corresponding to respective touch surfaces, and a single or multiple projectors 22 could be project images on the multiple surfaces.

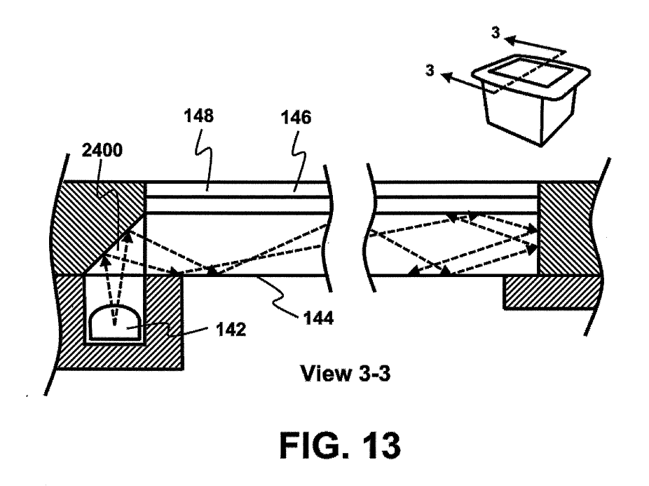

While a bank of infrared LEDs 142 has been described as the infrared light source directly emitting light into the optical waveguide layer 144 for the touch table, it will be understood that alternatives are available. For example, a Fresnel lens could be employed to collimate the emitted light into the optical waveguide layer 144. Alternatively or in some combination, a prism could be employed in between the LEDs and the optical waveguide layer 144 in order to reduce heat transmission to the optical waveguide layer 144. As seen in FIG. 13, a prism 2400 is placed along at least one edge of the optical waveguide layer 144 with a reflective hypotenuse for directing illumination from IR LED 142 into the optical waveguide layer 144. The edge of the optical waveguide layer 144 or the prism 2400 could be treated with an antireflective coating that would allow the IR light to enter the edge of the optical waveguide layer 144, but not escape along the edge. Alternatively, the edge of the optical waveguide layer 144 could be beveled and coated along the hypotenuse to reflect the IR light. This arrangement would allow the size of the table top 12 to be reduced, and the IR LEDs would accordingly be positioned so as not to unduly affect the projected image.

While individual touch points have been described above as being characterized as ellipses, it will be understood that touch points may be characterized as rectangles, squares, or other shapes. It may be that all touch points in a given session are characterized as having the same shape, such as a square, with different sizes and orientations, or that different simultaneous touch points be characterized as having different shapes depending upon the shape of the pointer itself. By supporting characterizing of different shapes, different actions may be taken for different shapes of pointers, increasing the ways by which application programs may be controlled.

While the USB port/switch 34 described herein operates according to the ubiquitous Universal Serial Bus standard, other external data port/switch devices employing technologies such as Secure Digital, Compact Flash, MemoryStick, and so forth, may be employed. Furthermore, alternative or complementary security and configuration measures may be employed. For example, the recognition of a fingerprint on the touch surface may cause the touch table 10 to permit the user to use the touch table 10, and accordingly be configured for that user. The user's profile would be stored on a network accessible from processing structure 20, or directly stored on processing structure 20, for example.

As an alternative to the external port/switch 34, or in some combination with it, a wireless device in contact with or in the vicinity of the touch table 10 could communicate with the processing structure 20 to provide configuration information to the touch table 10, making use of technologies such as RFID (Radio Frequency Identification), Wireless USB, Bluetooth™, or other. The touch table 10 could initiate communications with the wireless device upon detecting placement of the wireless device on the touch panel 14, for example.

Although embodiments have been described with reference to the drawings, those of skill in the art will appreciate that variations and modifications may be made without departing from the spirit and scope thereof as defined by the appended claims.

What is claimed is:

1. A touch panel for an interactive input system comprising:
an optical waveguide layer; and
a resilient diffusion layer against the optical waveguide layer causing light traveling within the optical waveguide layer to escape only when compressed against the optical waveguide layer at one or more touch points.

2. The touch panel of claim 1, wherein the optical waveguide layer comprises an acrylic sheet.

3. The touch panel of claim 2, wherein at least one side surface of the acrylic sheet through which light enters the optical waveguide layer is polished.

4. The touch panel of claim 3, further comprising reflectors at the remaining side surfaces of the acrylic sheet for reflecting light back into the acrylic sheet.

5. The touch panel of claim 4, wherein the reflectors comprise reflective tape.

6. The touch panel of claim 1, wherein the resilient diffusion layer comprises a polymer coated fabric.

7. The touch panel of claim 6, wherein the polymer coated fabric comprises a polyvinylchloride (PVC) coated yarn.

8. The touch panel of claim 1, wherein the resilient diffusion layer comprises a backing that resists sliding of the resilient diffusion layer relative to the optical waveguide layer.

9. The touch panel of claim 8, wherein the backing has an array of projections thereon.

10. The touch panel of claim 1, further comprising a protective layer against the resilient diffusion layer opposite the optical waveguide layer.

11. The touch surface of claim 10, wherein the protective layer comprises a polyester film.

12. The touch surface of claim 10, wherein the protective layer, the resilient diffusion layer and the optical waveguide layer are clamped together.

13. The touch surface of claim 1, wherein the resilient diffusion layer is a display surface for presenting an image projected through the optical waveguide layer.

14. The touch surface of claim 1, wherein the optical waveguide layer comprises glass.

15. The touch surface of claim 1, wherein the resilient diffusion layer permits emission of varying amounts of escaping light as a function of the degree to which it is compressed against the optical waveguide layer.

16. An interactive input system comprising:
a touch panel comprising:
an optical waveguide layer; and
a resilient diffusion layer against the optical waveguide layer causing light traveling within the optical waveguide layer to escape only when compressed against the optical waveguide layer at one or more touch points; and
processing structure responsive to touch input made on said touch panel and updating the image presented on said display surface to reflect user input based on the one or more touch points.

17. The interactive input system of claim 16, wherein the optical waveguide layer comprises an acrylic sheet.

18. The interactive input system of claim 16, wherein an edge of the acrylic sheet corresponding to a source of the light is polished.

19. The interactive input system of claim 18, further comprising reflectors on the remaining edges of the acrylic panel for reflecting light back into the acrylic sheet.

20. The interactive input system of claim 19, wherein the reflectors comprise reflective tape.

21. The interactive input system of claim 16, wherein the resilient diffusion layer comprises a polymer coated fabric.

22. The interactive input system of claim 21, wherein the polymer coated fabric comprises a polyvinylchloride (PVC) coated yarn.

23. The interactive input system of claim 16, wherein the resilient diffusion layer comprises a backing that resists sliding of the resilient diffusion layer relative to the optical waveguide layer.

24. The interactive input system of claim 23, wherein the backing has an array of projections thereon.

25. The interactive input system of claim 16, further comprising a protective layer against the resilient diffusion layer opposite the optical waveguide layer.

26. The interactive input system of claim 25, wherein the protective layer comprises a polyester film.

27. The interactive input system of claim 25, wherein the protective layer, the resilient diffusion layer and the optical waveguide layer are clamped together.

28. The interactive input system of claim 16, wherein the resilient diffusion layer is a display surface for presenting an image projected through the optical waveguide layer.

29. The interactive input system of claim 16, wherein the optical waveguide layer comprises glass.

30. The interactive input system of claim 16, wherein the resilient diffusion layer permits emission of varying amounts of escaping light as a function of the degree to which it is compressed against the optical waveguide layer.

31. The interactive input system of claim 16, further comprising a projector receiving image data from said processing structure and projecting images for presentation on the display surface.

32. The interactive input system of claim 31, further comprising a mirror system for receiving the projected images and reflecting the projected images onto the resilient diffusion layer.

33. The interactive input system of claim 31, wherein the mirror system comprises three mirrors.

34. The interactive input system of claim 32, further comprising an imaging device aimed at a mirror of the mirror system so that the imaging device sees a reflection of the touch panel.

35. The interactive input system of claim 32, wherein the processing structure receives images captured by the imaging device and performs image processing to characterize any pointers touching the touch panel.

36. The interactive input system of claim 35, wherein the light traveling through the optical waveguide layer is infrared light.

37. The interactive input system of claim 36, wherein the imaging device captures only infrared light.

38. The interactive input system of claim 37, further comprising a filter for substantially removing infrared light from the projected image prior to reaching the mirror system.

39. The interactive input system of claim 16, wherein the touch panel is mounted atop a cabinet housing the processing structure.

40. The interactive input system of claim 39, wherein the cabinet substantially blocks ambient light from entering the cabinet.

41. The interactive input system of claim 40, further comprising at least one fan for drawing out heat generated by at least the processing structure from the cabinet.

42. The interactive input system of claim 41, further comprising a duct for channeling heat exhausted by the processing structure directly to the at least one fan.

43. The interactive input system of claim 41, further comprising at least one fan for drawing ambient air from the exterior of the cabinet to its interior.

44. The interactive input system of claim 16, further comprising a bank of light emitting diodes (LEDs) for emitting light into an edge of the optical waveguide layer.

45. The interactive input system of claim 44, wherein there is a space between the bank of LEDs and the optical waveguide layer.

46. The interactive input system of claim 45, wherein the space is about 1-2 millimetres.

47. The interactive input system of claim 39, further comprising at least one provision for channeling and drawing hot air out of the cabinet.

48. The interactive input system of claim 32, further comprising at least one provision for channeling and drawing hot air away from the mirror system.

49. Use of V-CARE® V-LITE® as a resilient diffusion layer for a frustrated total internal reflection (FTIR) touch sensitive interactive input system.
